(19) United States
(12) Patent Application Publication
(10) Pub. No.: US 2008/0068208 A1
(43) Pub. Date: Mar. 20, 2008

(54) Method and apparatus for remotely operating a vehicle

(75) Inventor: Brian Hanselman, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/517,158

(22) Filed: Sep. 7, 2006

(51) Int. Cl. G08C 19/00

(52) U.S. Cl. 340/825.72; 307/10.6; 340/5.64; 123/179.2; 123/179.3

(57) ABSTRACT

A system is provided for remote starting of a vehicle. The system includes a transmitter adapted to transmit a command signal and a vehicle. Onboard the vehicle is an engine, a receiver, adapted to accepting the command signal, and an occupant detection system. The occupant detection system may be part of an airbag occupant detection system, for example. The occupant detection system generates a signal indicating whether at least one occupant is in the vehicle. A processor generates a start request signal in response to the command signal and occupant signal if the occupant signal indicates that no occupants are in the vehicle. Occupant detection can be by means of detecting pressure, weight or capacitance on a seat or other suitable means.

### TECHNICAL FIELD

The present invention relates to the field of remote engine starting systems and more particularly to safety features for remote engine starting systems.

### BACKGROUND

Remote starting of motor vehicles may be desirable, including for example when an operator wishes to start a vehicle during cold weather before entering the vehicle.

Remote starting systems typically include a hand-held radio-transmitter unit (often incorporated into a key fob) that is actuated by an operator to transmit a command signal to a nearby motor vehicle. The motor vehicle is equipped with a receiver that receives the command signal and a controller that starts the vehicle's engine.

Security and safety are two considerations in designing a remote starting system. For example, systems are known that provide encoding schemes to enable a vehicle to authenticate a remotely transmitted command signal as having originated from an authorized key fob. Remote starting systems have also been developed to inhibit the starting of the vehicle if the vehicle's doors are opened or if certain vehicle controls are actuated, such as the hazard lights.

It would be desirable to provide additional safety features for remote starting systems without substantially increasing the cost of manufacturing a remote starting system.

### SUMMARY

In the disclosed embodiments, a method and apparatus for remote operation of a vehicle is provided that reduces the chances of mishap by inhibiting operation of the vehicle if occupants are in the vehicle or if other vehicle environmental conditions exist. In accordance with one aspect of the invention, a method for remotely placing a vehicle into an operative state is provided. The method comprises accepting a remotely-transmitted command to transition a vehicle from a non-operative state to an operative state; detecting whether there is an occupant in at least one seat of the vehicle; placing the vehicle into the operative state in response the remotely-transmitted command, when an no occupant is detected in the at least one seat; and preventing the vehicle from entering the operative state when at least one occupant is detected in the vehicle.

In accordance with another aspect of the invention, an apparatus for controlling a vehicle in response to a remotely-transmitted signal is provided. The apparatus includes a receiver that accepts a remotely-transmitted command to transition a vehicle from a non-operative state to an operative state; an occupant detection sensor associated with at least one seat that detects the presence of an occupant in the at least one seat; and a controller operatively coupled to the receiver and the occupant detection sensor and adapted to generate a request signal in response to the remotely-transmitted command if no occupant is detected in the at least one seat by the vehicle by the occupant detection sensor. The apparatus also includes a vehicle controller responsive to the request signal to transition the vehicle from a non-operative state to an operative state.

In accordance with another aspect of the invention, a system adapted for remote starting of a vehicle is provided. The system includes a transmitter adapted to transmit a command signal and a vehicle. Onboard the vehicle are an engine; a receiver adapted to accept the command signal; an occupant detection sensor that generates an empty-vehicle signal if no occupant is in the vehicle; a processor operatively coupled to the receiver and the occupant detection sensor and adapted to generate a start request signal in response to the command signal and the empty-vehicle signal; and an engine controller responsive to the request signal to start the engine.

### BRIEF DESCRIPTION OF THE DRAWINGS

The description herein makes reference to the accompanying drawings wherein like reference numerals refer to like parts throughout the several views, and wherein:

FIG. 1 is a block diagram of a system for remotely operating a vehicle in accordance with a first embodiment of the invention;

FIG. 2 is a flow chart illustrating the method of operation of the system of FIG. 1;

FIG. 3 is a flow chart illustrating the method of operation of the system of FIG. 1 in accordance with a second embodiment of the invention; and

FIG. 4 is a block diagram of a system for remotely operating a vehicle in accordance with a third embodiment of the invention.

### DETAILED DESCRIPTION OF THE EMBODIMENTS

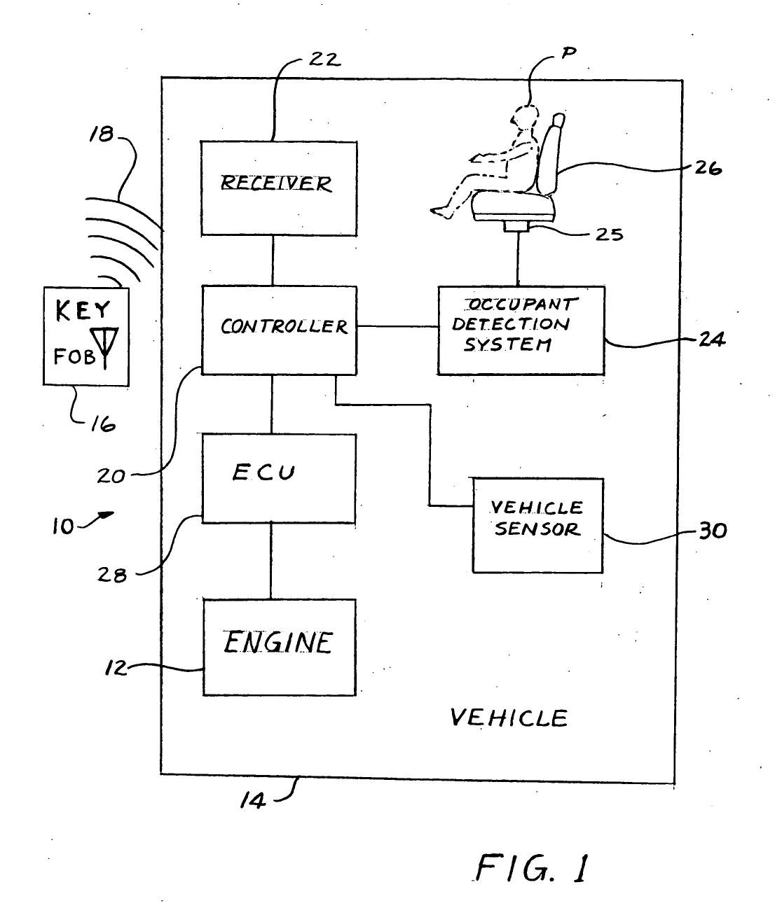

Referring to FIG. 1, remote starting system 10 is illustrated for remote starting of an engine 12 on a vehicle 14, in accordance with a first embodiment of the invention. As explained below, remote starting system 10 inhibits remote starting of engine 12 if at least one occupant is detected in vehicle 14.

Remote starting system 10 includes a hand-held, user-actuated transmitter 16, which can be a key fob. Upon actuation by a user, such as by pushing a button (not shown), transmitter 16 transmits a command signal 18. If desired, transmitter 16 can be a stationary base unit. It can also be actuated by means of a timer or a signal remotely transmitted from yet another location (such as by telephone or computer). Transmitter 16 can transmit command signal wirelessly, such as by radio frequency, to permit convenient remote actuation by the user. In lieu of radio frequency, command signal 18 can be carried by another frequency such as infra-red or by sound. Alternatively, transmitter could be coupled to vehicle 14 by wire such as a releasable cable so that the signal 18 need not be transmitted wirelessly.

With continuing reference to FIG. 1, remote starting system 10 also includes a controller 20, which can be a conventional microcomputer that is programmed in accordance with the first embodiment, and a receiver 22. Receiver 22 is adapted to accept command signal 18 and to convert it to digital or analog signal which is accepted as input by controller 20. Remote starting system 10 also includes an occupant detection system 24 that is related to at least one seat 26 in vehicle 14. Occupant detection system 24 can include a sensor 25 within a seat 26. Sensor 25 detects whether an occupant P (shown in phantom lines) is occupying seat 26, and generates an occupant signal indicative of whether there are one or more occupants in the vehicle. The occupant signal is received as input by controller 20.

Controller 20 is in electronic communication with a vehicle controller, which in this case is engine control unit (“ECU”) 28. The vehicle controller can also be any other type of device that controls operation of vehicle 14 including, for example, a control circuit that directly controls the starter motor of a vehicle. ECU 28 that controls engine 12 and generates a starter signal that causes engine 12 to transition from a non-operational state to an operational state. For example, if engine 12 is an internal combustion engine, it can include a starter motor and ignition system (not shown). ECU 28 can activate the starter motor and ignition system to permit engine 12 to enter a running, operational state. Alternatively, if engine 12 is an electric motor, for example, engine control unit 28 can generate electronic signals to enable engine 12 to enter a running, operational state. ECU 28 can also generate signals to maintain engine 12 in a non-operational state, such as to shut-off engine 12 if it is running or to prevent engine 12 from starting if it is not running. ECU 28 can also generate diagnostic fault signals indicative of whether an engine fault condition exists.

Controller 20 can also in electronic communication with one or more vehicle condition sensors such as sensor 30. Vehicle conditions sensors detect conditions relating to whether it would be safe to remotely start a vehicle. These conditions can include whether the vehicle's engine cover or hood is open; whether the vehicle doors are closed and locked; and whether the doors are unlocked using the remote entry control fob (in this case incorporated into transmitter 16) or key.

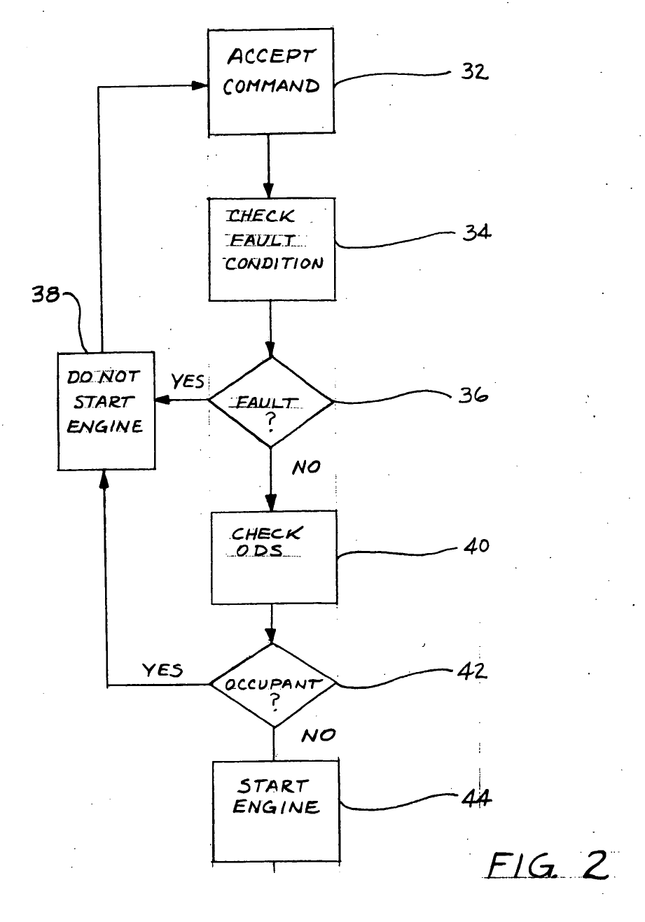

The operation of remote starting system 10 is explained with reference to FIG. 2. Beginning at block 32, when a user desires to remotely start vehicle 14, the user will actuate transmitter 16, causing it to transmit command signal 18. Command signal 18 is received by receiver 22 and converted to an analog or digital signal that is accepted as input by controller 20.

At block 34, controller 20 interrogates ECU 28 and sensor 30 to determine the existence of an engine fault condition or a vehicle fault conditions. At decision block 36, if an engine fault condition or vehicle fault condition exists, then control moves to block 38, where controller 20 inhibits starting of engine 12. This inhibition can be that controller 20 is programmed so that it does not transmit a start engine request to ECU if a fault condition is determined at block 36.

At decision block 36, if no fault condition exists, then control moves to block 40, where controller 20 interrogates the occupant detection system to determine if at least one occupant is in the vehicle. As explained above, occupant detection system is related to seat 26 and includes sensor 25 within seat 26, that detects whether occupant P is occupying seat 26. If occupant detection system 24 detects that an occupant P is occupying seat 26, then it generates an output signal indicating that at least one occupant P was detected. If occupant detection system 24 does not detect that an occupant P is occupying seat 26, then occupant detection system 24 generates an output an empty vehicle signal indicating that no occupants P were detected.

Controller 20 accepts as input the signal generated by occupant detection system 24. At decision block 42, if at least one occupant P is detected in vehicle 14, control moves to block 38, as described above, where controller 20 inhibits starting of engine 12. At decision block 42, if no occupant P is detected in vehicle 14, then control moves to block 44, where controller 20 generates as output a start engine request which is communicated to ECU 28. In response to the start engine request, ECU 28 starts engine 12.

For ease of illustration, an idealized controller 20 and ECU 28 are depicted. In practice, the functionality described here for controller 20 and ECU 28 can be distributed over a number of controllers or devices. The functionality described for controller 20 can be provided by means of software, firmware, or by creating specialized circuitry such as an application-specific integrated circuit. Signals referenced in this specification may be digital (such as a number or code communicated between digital devices) analog (such as a voltage, frequency or phase difference) or carried by wire or wirelessly, as expedient.

Occupant detection system 24 and sensor 25 can be implemented in a variety of ways. Occupant detection system 24 can be the system that manages airbags or other passive restraint system. This allows use of an existing component without having to provide an additional specialized part. Alternatively, the processing functionality of occupant detection system 24 in assessing the output of sensor 25 can be consolidated into controller 20, so that controller 20 reads the raw output of sensor 25 to determine whether an occupant is in vehicle 14.

Sensor 25 can include a number of implementations. It can be one sensor coupled to one seat or include sensors in multiple seats of vehicle 14. Generally, if the occupant is a person occupying the driver's seat, it can be judged that remote starting is acceptable and will not be inhibited. In that case, sensor 25 can be deployed only in passenger seats. In that case, the detection of a no occupant or empty vehicle condition of vehicle 14 corresponds to the condition of no occupants in the seats other than the driver's seat.

Sensor 25 can be adapted to detect pressure imposed on seat 26 as an indication that an occupant P occupies seat 26. Alternatively, sensor 25 can detect capacitance of a portion of the seat 26 and/or an object (such as occupant P) adjacent to seat 26. Other techniques for detecting an occupant P in vehicle 14 can be applied, including machine vision to inspect the passenger compartment and sensors to detect body heat of occupants.

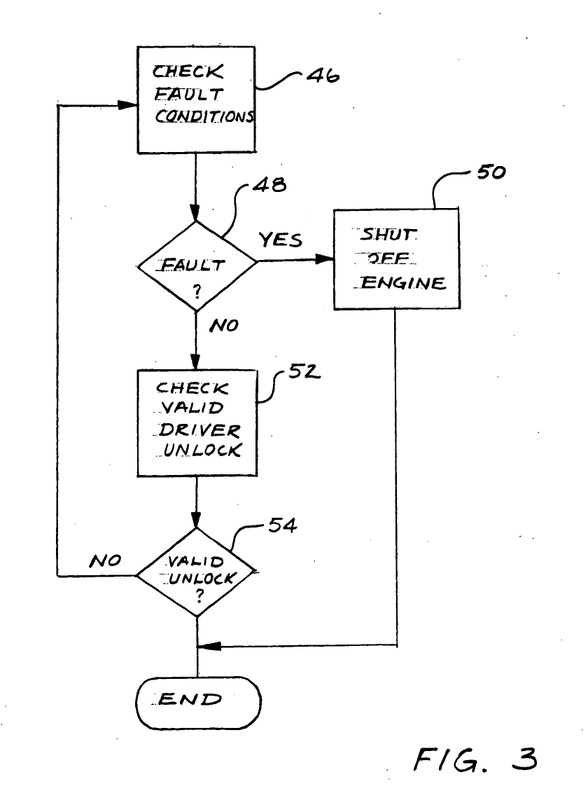

FIG. 3 illustrates operation of remote starting system 10 in accordance with a second embodiment of the invention. In this second embodiment, after engine 12 is started, controller 20 will monitor conditions of vehicle 14 and return engine 12 to a non-operative state if certain conditions of vehicle 14 are detected, as illustrated in FIG. 3. At block 46, controller interrogates one or more sensors or other devices to provide a fault signal. For example, at block 46, controller 20 can interrogate ECU 28 and vehicle sensor 30 to determine the existence of an engine fault condition or a vehicle fault conditions. Controller 20 can also interrogate occupant detection system 24 to determine if any occupants have entered the vehicle. At decision block 48, if a fault exists, control moves to block 50, where controller 20 generates a signal to ECU 28 requesting that engine 12 be turned-off or placed in a non-operational state. For purposes of decision block 46, a fault can be the occurrence of an engine fault as indicated by ECU 28, the occurrence of a vehicle fault as indicated by vehicle sensor 30 or the indication by occupant detection system 24 that at least one occupant is in the vehicle.

At decision block 48, no fault exists, then control moves to block 52, where controller 28 interrogates vehicle sensor 30 to determine if a valid driver door unlock condition exists. A valid driver door unlock condition can be when the driver's door is unlocked using the remote-entry key fob (in this case, part of transmitter 16) or key, for example. At decision block 54, if a valid driver door unlock condition exists, processing terminates, and remote starting system 10 discontinues monitoring conditions of vehicle 14 and engine 12, as illustrated in FIG. 3; however, the remote starting operations initiated by command signal 18 can otherwise continue. At decision block 54, if a valid driver door unlock condition does not exist, control returns to block 46 to repeat the monitoring process. Thus, when the user unlocks the driver's door using the key fob or key, it is judged that the driver is entering the vehicle and control over the continued operation of engine 12 will be in the driver's hands or under the ordinary control of ECU 28.

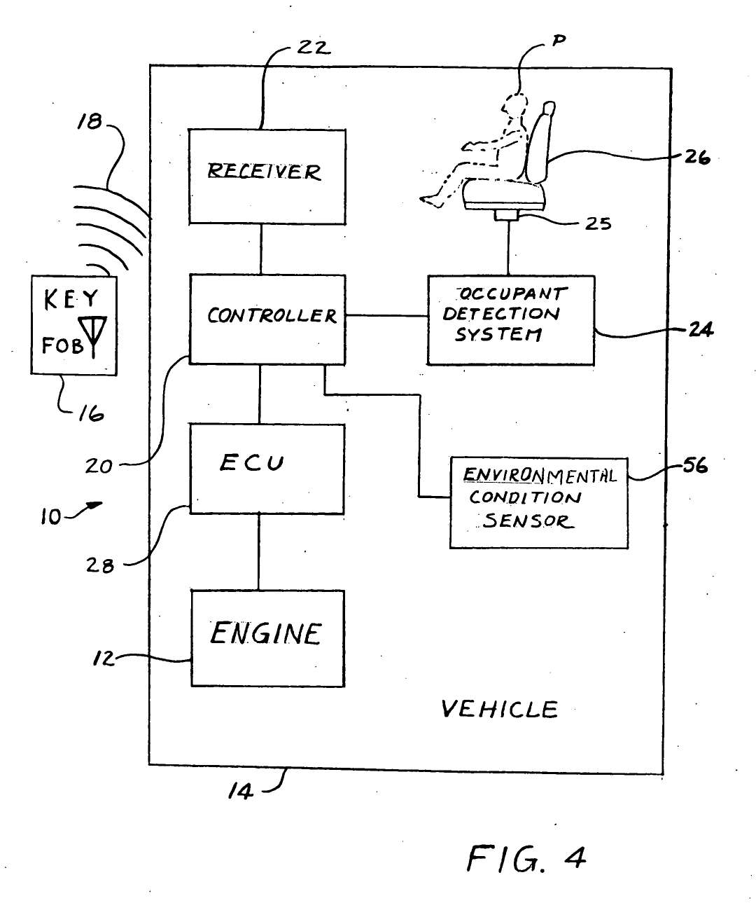

FIG. 4 illustrates remote starting system 10 in accordance with a third embodiment of the invention. The operation of remote starting system 10 as shown in FIG. 4 is the same as described above, except that as shown in FIG. 4, remote starting system 10 includes an environmental condition sensor 56. Environmental condition sensor 56 can include one or more sensors deployed in or on vehicle 14 to detect environmental fault conditions that make it potentially unsafe to remotely start engine 12. For example, environmental condition sensor 56 can detect the presence of carbon monoxide in proximity to vehicle 14 (wherein the presence of carbon monoxide is a fault condition that prevents the remote starting of engine 12 or requires that engine 12 be shut-down if already started). Environmental condition sensor 56 can include a camera and image processing hardware to detect the presence of people within a predetermined range outside of vehicle 14 (wherein the presence of people is a fault condition that prevents the remote starting of engine 12 or requires that engine 12 be shut-down if already started). The predetermined range can be, for example, within ten feet.

When remote starting system 10 is equipped with environmental sensor 56, the processing at step 34 in FIG. 2 can include the controller 20 interrogating environmental sensor 56 to determine if an environmental fault condition exists, and at decision block 36, the existence of an environmental fault can cause control to move to block 38, where controller 20 does not start engine 12. Likewise, the processing at step 46 of FIG. 3 can include interrogating environmental sensor 56 to determine if an environmental fault condition exists, and at decision block 48 the existence of an environmental fault can cause control to move to block 50, where controller 20 shuts-off engine 50.

In the embodiments of FIGS. 1-4, the operational state that was remotely activated by command signal 18 was the engine 12 being turned on. Additional and different operational states can be activated as well in accordance with the invention. For example, in response to command signal 18, controller 20 can activate the heater, seat heater, defroster or air conditioning units (not shown) of vehicle 14, through vehicle controllers that can be different than ECU 28.

The embodiments can be practiced with other features as well. Transmitter 16 can have a dedicated button to generate command signal 18. Or, to avoid accidental starting, transmitter 16 can have one or more buttons that the user must press in a predetermined sequence to transmit command signal 18. Vehicle 14 or transmitter 16 can provide feedback to the user to indicate that command signal 18 has been sent or that engine 12 has been started. Feedback can include flashing lights or beeping horn on vehicle 14 or generating a tone on transmitter 16, for example.

The above-described embodiments have been described in order to allow easy understanding of the present invention, and do not limit the present invention. On the contrary, the invention is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for remotely placing a vehicle into an operative state, comprising:
accepting a remotely-transmitted command to transition a vehicle from a non-operative state to an operative state;
detecting whether there is an occupant in at least one seat of the vehicle;
placing the vehicle into the operative state in response the remotely-transmitted command, when an no occupant is detected in the at least one seat; and
preventing the vehicle from entering the operative state when at least one occupant is detected in the vehicle.

2. The method of claim 1, wherein the non-operative state is a state in which an engine of the vehicle is not running and the operative state is a state in which the engine of the vehicle is running.

3. The method of claim 1, wherein the at least one seat is a passenger seat.

4. The method of claim 3, wherein detecting whether there is an occupant in at least one seat comprises sensing pressure imposed on the at least one seat.

5. The method of claim 3, further comprising providing an airbag occupant detection system, and wherein detecting whether there is an occupant in at least one seat compromises detecting the condition of the airbag occupant detection system.

6. The method of claim 3, wherein detecting whether there is an occupant in at least one seat comprises sensing capacitance of at least one of a portion of the at least one passenger seat and an object adjacent thereto.

7. The method of claim 1, further comprising detecting whether at least one vehicle fault condition exists, and maintaining the vehicle in a non-operative state if the vehicle fault condition exists.

8. The method of claim 1, wherein the remotely-transmitted command is transmitted via a radio frequency signal.

9. The method of claim 1, further comprising wherein detecting whether there is an occupant in at least one seat after placing the vehicle into the operative state in response to the remotely-transmitted command; and returning the vehicle to a non-operative state when an occupant is detected in the at least one seat.

10. The method of claim 1, further comprising detecting a vehicle environmental condition.

11. The method of claim 10, wherein the detected vehicle environmental condition is the level of carbon monoxide in proximity to the vehicle.

12. The method of claim 10, wherein the detected vehicle environmental condition is the presence of at least one person within a predetermined range outside of the vehicle.

13. An apparatus for controlling a vehicle in response to a remotely-transmitted signal, the apparatus comprising:
a receiver that accepts a remotely-transmitted command to transition a vehicle from a non-operative state to an operative state;
an occupant detection sensor associated with at least one seat that detects the presence of an occupant in the at least one seat;
a controller operatively coupled to the receiver and the occupant detection sensor and adapted to generate a request signal in response to the remotely-transmitted command if no occupant is detected in the at least one seat by the vehicle by the occupant detection sensor; and
a vehicle controller responsive to the request signal to transition the vehicle from a non-operative state to an operative state.

14. The apparatus of claim 13, wherein the non-operative state is a state in which an engine of the vehicle is not running and the operative state is a state in which the engine of the vehicle is running, and wherein the vehicle controller is a starter controller.

15. The apparatus of claim 13, wherein the occupant detection sensor detects a pressure imposed on the seat.

16. The apparatus of claim 13, wherein the occupant detection sensor detects capacitance of at least one of the following: a portion of the seat and an object adjacent to the seat.

17. The apparatus of claim 13, further comprising an engine controller adapted to generate a fault signal if a vehicle fault condition exists, wherein the controller is further adapted to maintain the vehicle in a non-operative state in response to the fault signal.

18. An apparatus adapted for remote starting of a vehicle, comprising:
a transmitter adapted to transmit a command signal;
a vehicle including:
an engine;
a receiver adapted to accept the command signal;
an occupant detection sensor that generates an empty-vehicle signal if no occupant is detected in the vehicle;
a controller operatively coupled to the receiver and the occupant detection sensor and adapted to generate a start request signal in response to the command signal and the empty-vehicle signal; and
an engine controller responsive to the request signal to start the engine.

19. They system of claim 19, wherein the occupant detection sensor is operatively coupled to at least one seat in the vehicle to detect whether an occupant is occupying in the seat.
